(19) United States
(12) Patent Application Publication
(10) Pub. No.: US 2013/0151750 A1
(43) Pub. Date: Jun. 13, 2013

(54) MULTI-ROOT INPUT OUTPUT VIRTUALIZATION AWARE SWITCH

(71) Applicants: Balaji Kanigicherla, Hyderabad (IN); Dhanumjai Pasumarthy, Hyderabad (IN); Shabbir Haider, Hyderabad (IN); Tapan Vaidya, Hyderabad (IN); Paulraj Kanakaraj, Hyderabad (IN); Naga Murali Medeme, Hyderabad (IN)

(72) Inventors: Balaji Kanigicherla, Hyderabad (IN); Dhanumjai Pasumarthy, Hyderabad (IN); Shabbir Haider, Hyderabad (IN); Tapan Vaidya, Hyderabad (IN); Paulraj Kanakaraj, Hyderabad (IN); Naga Murali Medeme, Hyderabad (IN)

(21) Appl. No.: 13/817,819

(22) PCT Filed: Aug. 19, 2011
(86) PCT No.: PCT/IN11/00556

§ 371 Date: Feb. 19, 2013

(30) Foreign Application Priority Data
Aug. 19, 2010 (IN) 2395/CHE/2010

(51) Int. Cl. G06F 13/40

(52) U.S. Cl. CPC G06F 13/4022
USPC 710/313

(57) ABSTRACT

A system having a multi protocol multi-root aware (MP-MRA) switch (102) configured to route data between multiple host processors (104) and multiple I/O devices (106) is described herein. In said embodiment, the MP-MRIOV aware switch includes a switch routing module (108), at least one upstream adaptive module (110), and at least one downstream adaptive module (112). The upstream adaptive module (110) is configured to map information in a primary communication protocol to a intermediate communication protocol at which the switch routing module operates. Further, the downstream adaptive module (112) maps the intermediate communication protocol to a secondary communication protocol at which the I/O device (106) operates.

### TECHNICAL FIELD

The present subject matter relates, in general, to a Peripheral Component Interconnect Express (PCIe) switch and, in particular, to a PCIe switch aware of multiple host processors.

### BACKGROUND

Computing systems, for example desktop computers, hand held devices, etc., utilize buses and input-output (I/O) devices, both of which operate on an industry standard system level bus interconnect protocol called Peripheral Component Interconnect (PCI) standard. The PCI standard specifies a bus for attaching I/O devices to a computing system. Additionally, the PCI standard allows an I/O device to communicate with the computing system using pre-defined commands and exchange information such as interrupts, errors and other messages. However, to meet the demands of higher performance, and increased scalability and flexibility, a standard utilizing point to point transmission, having a higher speed and, which is scalable for future improvements, known as PCI Express (PCIe) protocol was developed by the Peripheral Component Interconnect Special Intel cst Group (PCI-SIG).

The PCIe protocol supports I/O virtualization. I/O virtualization relates to capability of the I/O devices to be used by more than one system image, i.e., by more than one operating system executing on a single host processor. For this, a single root input-output virtualization (SRIOV) standard has been developed by the PCI-SIG. The SRIOV standard is used in an SRIOV aware switch to route information between the single host processor having multiple system images and virtualized I/O devices. The capabilities of the SRIOV aware switch have been extended by a multi root input-output virtualization (MRIOV) aware switch to allow sharing of the I/O devices between multiple host processors based on the standards of MRIOV provided by the PCI-SIG.

As mentioned before, the PCIe protocol is generally used in computer and server systems as an inter-chip and inter-board communication protocol. However, integration of a root complex, the MRIOV switch and, the PCIe compliant I/O devices on one chip and in conformance with PCIe standard is both area consuming and cost intensive. Further, a lot of PCIe capabilities may not be needed for on-chip communication. In addition, even though the PCIe protocol is implemented in some systems, there are several devices operating on other communication protocols, for example Advanced Extensible Interface (AXI). However, the MRIOV switch is defined to work on PCIe standards only, thereby causing the devices working on other communication protocols incompatible.

### SUMMARY

This summary is provided to introduce concepts related to a multi-root input output virtualization aware switch, which are further described in the detailed description. This summary is not intended to identify essential features of the present subject matter nor is it intended for use in determining or limiting the scope of the present subject matter.

In an embodiment, a system having a multi protocol multi-root input output virtualization aware switch configured to route data between multiple host processors and multiple I/O devices is described herein. In said embodiment, the multi protocol multi-root input output virtualization aware switch includes a switch routing module, an upstream adaptive module, and a downstream adaptive module. The upstream adaptive module is configured to map information in a primary communication protocol to an intermediate communication protocol at which the switch routing module operates. Further, at least one downstream adaptive module maps the intermediate communication protoco to a secondary communication protocol at which the I/O device operates.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a computing system implementing a multi-protocol multi-root aware switch, in accordance with an embodiment of the present subject matter.

FIG. 2 illustrates an upstream adaptive module, in accordance with an embodiment of the present subject matter.

FIG. 3 illustrates a downstream adaptive module, in accordance with an embodiment of the present subject matter.

FIG. 4 illustrates method of mapping one protocol to another using the multi-protocol multi-root aware switch, in accordance with an embodiment of the present subject matter.

### DETAILED DESCRIPTION

Conventionally, a host processor is associated with one or more dedicated I/O devices (also referred to as end point devices). However, such I/O devices may not be in operation at all times end may spend a large amount of time in idle state, resulting in device inefficiencies. To end, I/O virtualization is implemented to share I/O resources efficiently by detaching the physical function of an I/O device from the host processor and virtualizing the I/O resources to make them available to multiple system images. As a result of the I/O virtualization, the virtualized I/O device appears as a dedicated resource to each of the system images.

Additionally, the standard for virtualizing I/O devices and further, routing information between the virtualized I/O devices and multiple host processors using MRIOV aware switch based on PCIe protocol have been defined by the PCI-SIG in the MRIOV standard. The MRIOV standard defines how an MRIOV aware switch can be implemented in a PCIe environment, which enables multiple ports to simultaneously share PCIe compliant I/O devices. However, the MRIOV standard does not define how to implement the MRIOV aware switch for other communication protocols and/or for I/O devices that Are compliant with these communication protocols. Examples of the other widely used communication protocols include but are not limited to Virtual Component interface (VCI), Basic Virtual Component Interface (BVCI), Advanced Extensible Interface (AXI), Advanced High Performance Bus (AHB), Advanced Virtual Component Interface (AVCI), Open Code Protocol (OCP), Peripheral Virtual Component Interface (PVCI), Brain Computer Interface (BCI), etc. Since, there are significant differences between PCIe protocol and the other inter-connect protocols, hosts and devices based on other inter-connect protocols cannot communicate with each other through a PCIe MRIOV switch.

The embodiments described herein will help address the aforementioned issues in addition to providing several other advantages over the existing schemes for routing information between the multiple host processors and the I/O devices. In one embodiment, a multi-protocol multi root aware switch (MPMRA) switch routes data between multiple host processors and multiple endpoint devices adhering to different communication protocols.

To this end, the MPMRA switch includes a switch routing module, an upstream adaptive module, and a downstream adaptive module. The upstream adaptive module is configured to map information in a primary communication protocol to a intermediate communication protocol at which the switch routing module operates. Further, at least one downstream adaptive module maps the intermediate communication protocol to a secondary communication protocol at which the I/O device operates.

System(s) implementing the disclosed method(s) include, but are not limited to, desktop computers, hand-held devices, multiprocessor systems, microprocessor based programmable consumer electronics, laptops, network computers, minicomputers, mainframe computers, and the like.

While aspects of described systems and methods of the MRIOV aware switch can be implemented in any number of different computing systems, environments, and/or configurations, the embodiments are described in the context of the following system architecture(s). Additionally, the word “connected” is used throughout for clarity of the description and can include either a direct connection or an indirect connection. The descriptions and details of well-known components are omitted for simplicity of the description. Further, some components that have been shown on-chip may be implemented off-chip as will be understood by a person skilled in the art.

Although the present subject matter has been explained with reference to a specific communication protocol, it will be appreciated by those skilled in the art that the mapping and routing of the data should not be limited to the specific communication protocol and thus, that the description can be extended to all possible communication protocols like VCI, BVCI, AXI, AHB, AVCI, OCP, PVCI, BCI, etc., with a few modifications as will be understood by a person skilled in the art.

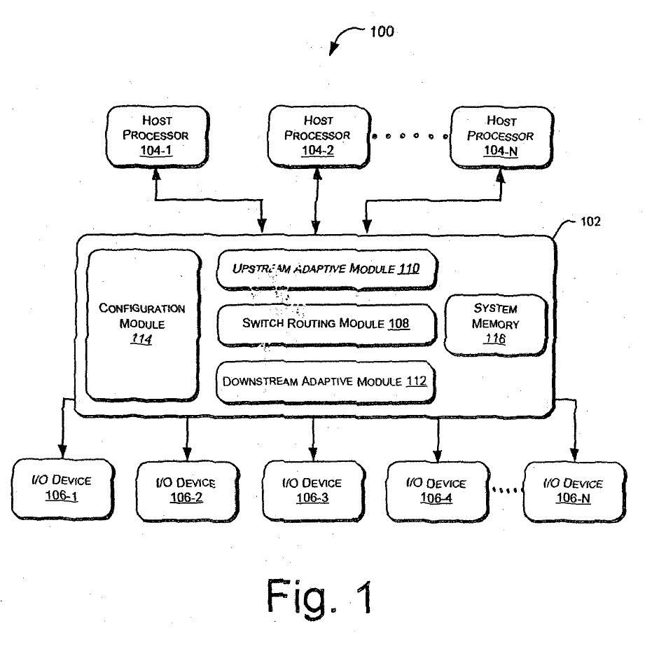

FIG. 1 illustrates a computing system 100 implementing the MPMRA switch 102, according to an embodiment of the present subject matter. The MP-MRA switch 102 has been interchangeably referred to as system 102 hereinafter. In one embodiment, the computing system 100 includes host processors 104-1, 104-2, . . . , 104-N, collectively referred to as host processor(s) 104. The computing system 100 further includes the MPMRA switch 102 and I/O devices 106-1, 106-2, . . . , 106-N, collectively referred to as I/O device(s) 106. Examples of the I/O devices 106 include USB devices, storage devices, communication devices, human interface devices, and audio devices. Additionally, the I/O device 106 may be a storage device, which boots one or more host processors 104.

The host processors 104 may include microprocessors, microcomputers, microcontrollers, digital signal processors, central processing units, state machines, logic circuitries, and/or any devices that manipulate signals and data based on operational instructions. Among other capabilities, the host processors 104 are individually configured to interact with the MPMRA switch 102 through their respective root complexes (not shown in the figure). In one embodiment, the host processors 104 work on different protocols. For example, the host processor 104-1 works on the AXI communication protocol; while the host processor 104-2 is based on the PCIe communication protocol. Additionally, the host processors 104 may be configured to execute different operating system images

In operation, the MPMRA switch 102 receives information such as commands, interrupts, messages, etc., from the host processors 104 and routes the information to the desired I/O devices 106. For this purpose, the MPMRA switch 102 includes a switch routing module 108, at least one upstream adaptive module 110, and at least one downstream adaptive module 112. It should be noted that although a single upstream adaptive module 110 and a single downstream adaptive module 112 have been shown, the MPMRA switch 102 may have protocol specific upstream and downstream adaptive modules, i.e., there may be multiple upstream adaptive modules and multiple downstream adaptive modules. Further, the number of upstream adaptive modules and number of downstream adaptive modules may be different depending on the number of different protocol implemented host processors 104 and I/O devices 106. The switch routing module 108 is a typical switching unit capable of routing information between the PCIe compliant host processors 104 and the I/O devices 106 based on switch configuration registers (not shown). The switch routing module 108 may act as multi-root aware switch to implement the information switching functionality among host processors 104 and the I/O devices 106.

However, as mentioned before, the host processors 104 and the I/O devices 106 may be configured to operate on different communication protocols. Thus, for routing information between non-PCIe compliant host processors and I/O devices the MPMRA switch 102, through the upstream adaptive module 110, determines the communication protocol in which the information is received, applies adaptation logic to translate the information into PCIe compliant information, and subsequently sends the translated information to the switch routing module 108. The upstream adaptive module 110 also receives information from switch routing module 108 in the PCIe compliant format and translates it to required non-PCIe complaint information required by the host processor 104. On the other hand, the downstream adaptive module 112 receives information from the switch routing module 108 in PCIe protocol and sends the information to the desired I/O device 106 in a format desired by the I/O devices 106. Similarly the downstream adaptive module 112 can receive information from the Desired I/O device 106 in a non-PCIe format and convert that to a PCIe protocol and send it to switch routing module 108.

As an illustration, consider that the host processor 104-1 sends an information in AXI protocol for the I/O device 106-1. Subsequently, the host processor 104-2 sends the information in PCIe protocol for accessing the PCIe compliant I/O device 106-2. In such a scenario, the upstream adaptive module 110 translates the information of the host processor 104-1 into a PCIe protocol format, thereby making the information compatible for the switch routing module 108. Further, the switch routing module 108 transfers the information to the I/O device 106-1. If the I/O device 106-1 is not PCIe compliant, then the downstream adaptive module 112 converts the routed information into the format acceptable by the I/O device 106-1. In case both the I/O device and the host processor are PCIe compliant as in the case of host processor 104-2 and the I/O device 106-2, the information is directly routed through the switch routing module 108 without any adaptation since the information is already PCIe compliant.

In operation, the MPMRA switch 102 performs the translation on the basis of pre-defined parameters such as address spaces, completion status, traffic classes, atomic operations, and split completions. Further, in one implementation, the MPMRA switch 102 may choose a parameter based on the communication protocol of the host processors 104 and/or the I/O devices 106. For example, to translate a request from the host processor 104-1 operating on primary communication protocol, for example AXI into another communication protocol, like PCIe, the MPMRA switch 102 uses address spaces. This is further explained below in context of the AXI communication protocol.

The AXI communication protocol uses a single address space, whereas the PCIe communication protocol uses four different address spaces namely configuration address space, I/O address space, memory address space, and message address space. The mapping of the information stored in a single AXI address space to PCIe configuration address space, I/O address space, and memory address space is handled via address decoding. Through address decoding, three regions of the AXI address space are mapped onto the PCIe configuration, I/O, and memory spaces, respectively. In one implementation, the start address of each of the three different regions is programmed using a configuration module 114. Further, the start address helps in relocating the regions, if need be. Even though the configuration module 114 has been shown external and common to the upstream adaptive module 110 and the downstream adaptive module 112, it will be understood that each of the upstream adaptive module 110 and the downstream adaptive module 112 may have a configuration module of its own. Additionally, the configuration module 114 may be programmed either by a root port or by a separate port.

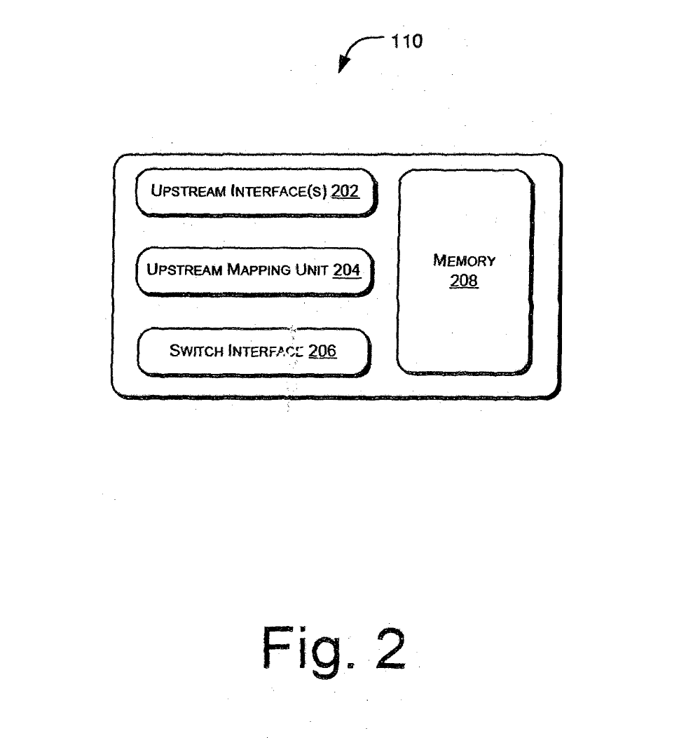

The messages in the message address space are exchanged through programming registers stored in the configuration module 114. In another implementation, the messages are stored directly in a dedicated system memory 116. In yet another implementation, the system memory 116 may be included in each of the upstream adaptive module 110 and the downstream adaptive module 112. The system memory 116 may include a computer-readable medium known in the art including, for example, volatile memory, such as static random access memory (SRAM), dynamic random access memory (DRAM), etc., and/or non-volatile memory, such as erasable program read only memory (EPROM), flash memory, etc. The operation of exchanging messages is further explained with reference to FIG. 2.

As mentioned before, the MPMRA switch 102 performs the translation on the basis of completion status responses as well. This is desired since there are differences between one communication protocol and the other. Thus, in one implementation, the MPMRA switch 102 also translates the definitions of completion status responses from one communication protocols to another protocol. In addition, some information may be carried over sideband signals.

For example, PCIe protocol defines four different completion status responses in response to a transaction layer packet (TLP). The completion status responses in PCIe protocol include successful completion (SC), unsupported request (UR), configuration request retry status (CRS), and completer abort (CA), while the completions status responses in AXI protocol include OKAY, EXOKAY, DECERR, SLVERR. The MPMRA switch 102 maps the SC with OKAY response, the UR is mapped with DECERR and additional information is carried over sideband signals based on read/write response, CA with SLVERR with cause of error indicated in the configuration module 114 or sideband signals. For CRS, the upstream adaptive module 110 retries a configuration request as CRS is valid only for host processors 104.

In one implementation, it is possible that multiple AXI read operations can be sent with the same ARID, and since the PCI express protocol does not guarantee in-order completion for outstanding transactions, the MPMRA switch 102 is configured to track outstanding requests of the upstream adaptive module 110 and the downstream adaptive module 112. In said implementation, the upstream adaptive module 110 and the downstream adaptive module 112 may support up to 32 outstanding requests, when extended tag is not supported and up to 256 outstanding requests when extended tag is supported. In implementation, to track the outstanding transactions, the upstream adaptive module 110 and the downstream adaptive module 112 may implement a set of registers. The set of registers may include a USED_TAG bit corresponding to each outstanding transaction along with the ARID associated with the transaction. Further, an additional OOO_REQ bit may also be implemented to identify the presence of a same ARID for a previously sent transaction. The set of registers corresponding to the outstanding transactions may be implemented in the upstream adaptive module 110 and the downstream adaptive module 112, or may be implemented in the configuration module 114.

Also, for each received completion in the PCIe protocol, either by the upstream adaptive module 110 and the downstream adaptive module 112 based on the tag in the completion TLP, the ARID of the completion is read. The read ARID may then be compared against the ARIDs of all the outstanding transactions whose tag modulo32 is less than the currently received tag. A found match indicates that the received completion is out-of-order. However, an unfound match indicates an in-order completion TLP. The data from an out-of-order completion TLP may be stored in a memory, such as the system memory 116. Further, the entry in the register set may be removed by clearing the USED_TAG bit. It would be understood that outstanding transactions with tag modulo32 less than the tag of the received tag are only compared since the upstream adaptive module 110 and the downstream adaptive module 112 support 32 outstanding requests. If the upstream adaptive module 110 and the downstream adaptive module 112 would support requests less than 32, say 20, outstanding transactions with tag modulo20 less than the tag of the received tag would be compared. Further, as described above, if extended tag is supported, a max of 256 outstanding requests is possible.

Similarly, upon identification of an in-order TLP, a check may be made for any outstanding out-of-order responses present for the same ARID. Based on the check, the responses sent on after the current in-order packet, are sent over to the AXI protocol interface. It would be understood that no ordering may be required for tags of received completion TLPs when ARIDs are different.

In another implementation, a completion timeout mechanism may also be implemented by the upstream adaptive module 110 and the downstream adaptive module 112. The timeout mechanism may be implemented by counters inside the upstream adaptive module 110 and the downstream adaptive module 112 where a different counter can be used for each of the 32 outstanding transactions. In operation, when a TLP is transmitted with a particular tag, the corresponding counter is initialized. The counter is periodically decremented and if the counter expires before a corresponding completion is received, i.e., a completion TLP with a matching completion tag, the upstream adaptive module 110 and the downstream adaptive module 112 may send a DECERR response along with sideband signals indicating completion timeout.

Further, if the tag of a received completion TLP does not match any of the outstanding tags, or if there is a tag to match but the ID of the requestor does not match, the completion TLP may be treated as an unexpected completion. The unexpected completion may be indicated to the host processors 104 or the I/O devices 106 via an out-of-band signal sent from the upstream adaptive module 110 and the downstream adaptive module 112.

In another example, for mapping PCIe completion status responses with the completion status responses in AHB protocol, the MRPRA switch 102 maps the successful completion with OKAY response, the unsupported request with ERROR and sideband signal with timing as HRSEP, and completer abort with ERROR, and so on.

In one embodiment, the MPMRA switch 102 also maps the traffic classes from one communication protocol to another. In PCIe protocol, traffic class (TC) is defined as a transaction layer packet (TLP) label that is used to indicate the type of required service for that particular TLP. Depending on the quality of service needed, a TLP may have a different number. For example, PCIe supports TC0-TC7. Typically, the TC is transmitted unmodified end-to-end through the fabric. At every service point, such as the switch routing module 108, within the fabric, TCs are used to apply appropriate servicing policies. Generally, in the switch routing module 108, each of these TCs is mapped to a virtual channel (VC) which has its own independent fabric-resources, e.g., queues/buffers and associated control logic. Such VC resources may be used to prioritize arbitration for the flow of information. In one implementation, for communication protocols that have quality of service (QoS) signals, e.g., AXI4 protocol, the MPMRA switch 102 maps the TC numbers to certain encodings of such signals. For example, in the AXI4 protocol, the QoS for each of the TCs is carried by AWQOS and ARQOS encoding. The priority information is exchanged over sideband signals in an AXI3 domain over the AR and AW channels. Alternatively, in another implementation, different TCS may be mapped to different IDs (such as ARID, AWID, RID, WID, BID) along with associated ID decode unit (not shown in the figure). Whereas for communication protocols that do not have such QoS signals, e.g., AHB, the MPMRA switch 102 sends the priority information over sideband signals or control signals.

As mentioned before, the MPMRA switch 102 may also perform the translation of atomic operations. Atomic operations are single PCIe transaction targeting a location in memory space or configuration space of the host processor 104 or the I/O Device 106 which are memory mapped reads to the location's value, optionally writes a new value to the location, and returns the original value. This read-modify-write sequence to the location is performed atomically. Since there are differences between the atomic operations transfer of one communication protocol and the other, atomic operation translation is required. Thus, in one implementation, the MPMRA switch 102 also translates the PCIe atomic operations to atomic operations requests of other protocols, such as VCI, BVCI, AXI, AHB, AVCI, OCP, PVCI, BCI, etc.

For example, PCIe protocol defines three different atomic operations. Since the other protocols such as AXI does not directly support atomic operations, the request of such atomic operations by the I/O devices (106) (end points) or the host processors 104 has to be translated. The atomic operations in PCIe protocol include Fetch and Add (FETCHADD), Unconditional Swap (SWAP), and Compare and SWAP (CAS). To translate these atomic operations, the upstream adaptive module 110 and the downstream adaptive module 112 break the request into two different requests of on-chip protocols and their corresponding completions.

In one implementation, the two requests generated for the on-chip protocols corresponding to the atomic operations may be a locked read request and a locked write request. However, in said implementation, the locked write request for the atomic operation CAS may depend on the comparison of result of the read value and a compare value field, received after the CAS locked read request.

Further, the response of each of the separate requests is assembled by either of the upstream adaptive module 110 and downstream adaptive module 112 and a corresponding response is sent back to the requestor. The corresponding response may be sent as the completion status on PCIe along with the completion data, received based on the read data from the locked read request.

The MPMRA switch 102 is also configured to intercept split completions requests. PCIe enabled I/O devices 106 or the PCIe supporting host processors 104 may generate multiple completion requests for a given PCIe memory read request. The MPMRA switch 102 may intercept such completion requests and translate them into different completion status based on different on-chip protocols. In one implementation, the upstream adaptation module 110 and the downstream adaptation module 112 may receive the split completion status and redirect the request to the switch routing module 108.

FIG. 2 illustrates an upstream adaptive module 110, in accordance with an embodiment of the present subject matter. In said embodiment, the upstream adaptive module 110 includes an upstream interface(s) 202 having either one master port or one slave port or both master and slave ports to exchange information from any of the host processors 104 through their respective root complexes (not shown in the figure). The ports of the upstream interface 202 may be pre-configured such that a particular port receives information in a particular communication protocol.

In said embodiment, the upstream adaptive module 110 also includes an upstream mapping unit 204 to translate the information, defined in a certain protocol, to a protocol at which the switch routing module 108 operates. In an example, the switch routing module 108 is PCIe compliant. Further, the upstream mapping unit 204 performs translation on the basis of the communication protocols in question. In an example, the translation is based at least on address spaces, completion status, and traffic classes of the communication protocols as discussed in FIG. 1.

Further, the translated information from the upstream mapping unit 204 is routed to a switch interface 206, which further routes the translated information to the switch routing module 108. In one embodiment, the upstream adaptive module 110 is provided with a memory 208. The memory 208 may include a computer-readable medium known in the art including, for example, volatile memory, such as static random access memory (SRAM), dynamic random access memory (DRAM), etc., and/or non-volatile memory, such as erasable program read only memory (EPROM), flash memory, etc. In one implementation, the memory 208 may store the information and the translated information at run time.

The mapping of the information stored in a single AXI address space to PCIe configuration address space, I/O address space, and memory address space is handled via address decoding and has already been explained in detail with reference to FIG. 1. However, the description of the handling of PCIe messages, atomic operations and split completions in AXI is provided below with reference to FIG. 1 and FIG. 2.

The messages in the message address space are exchanged through programming registers stored in the configuration module 114. For example, when a message is generated by a host processor, say host processor 104-1, the host processor 104-1 updates the configuration module 114 via an upstream interface 202 with details regarding message header, message type, message destination, message payload, etc. In another implementation, the messages are stored directly in the memory 208.

The configuration module 114 notifies an upstream mapping unit 204 about a pending transmit message. Alternatively, the upstream mapping unit 204 may poll the configuration module 114 to check for pending transmit messages. In response to the notification, the upstream mapping unit 204 reads the message contents and converts it into a protocol that switch interface 206 understands, which then hands over the message contents to the switch routing module 108.

Similarly, in another implementation, a message generated by the I/O device 106 is delivered to the desired host processor 104-1 by first updating one or more programming registers within the configuration module 114 via the switch interface 206. In another implementation, the messages may stored in the memory 208.

Subsequently, the configuration module 114 notifies the upstream mapping unit 204 that a receive message is pending. In another case, the upstream mapping unit 204 may poll the configuration module 114 to check for pending receive messages. Subsequently, the upstream mapping unit 204 notifies host processor 104-1 via upstream interface 202 that a message is pending. In another case, the host processor 104-1 may poll the configuration module 114 to see if receive messages are pending. The message is read by the host processor 104-1 from the programming registers stored in the configuration module 114, after an event of handshake between the host processor 104-1 and the upstream interface 202.

In one implementation, the upstream adaptive module 110 may also translate the PCIe atomic operations and handle the split completions. Any host processor 104 may generate a PCIe atomic operation request, which can be a FETCHADD, a SWAP, or a CAS request. To initiate the atomic operation request, the host processor 104 writes to an ‘atomic operation type’ register of the upstream adaptive module 110 stored in the memory 208. The write in the ‘atomic operation type’ register is indicative of the type of atomic operation intended by the host processor 104. Further, the upstream adaptive module 110 sends a response to the requestor host processor 104 upon identifying an event of write.

For different atomic operations, the host processor 104 writes to different registers of the upstream adaptive module 110. For example, in one implementation, the host processor 104 may write onto a ‘compare value register’ for CAS operations, and may write onto a ‘swap’ register for SWAP and CAS operations. Further, in addition to the write request, the host processor 104 may issue a read request to an ‘initiate’ or a ‘atomic operation status’ register, stored in the memory 208 of the upstream adaptive module 110. The read event may trigger the PCIe atomic operation request generation. The Upstream adaptive module 110, upon identifying an event of read by a host processor 104 may generate a locked read and a locked write request, as explained in FIG. 1. The upstream adaptive module 110 further routes the locked read and write requests to the intended I/O device 106. Once the completion of the atomic operation is received by the upstream adaptive module 110 from the respective I/O device 106, a response is send to the requestor host processor 104.

Although, the handling of atomic operations is described with respect to upstream adaptive module 110, it would be understood by those skilled in the art that an atomic operation request may also be generated by an I/O device 106. In such a scenario, the downstream adaptive module 112 would handle such request and route them in a similar manner, as explained for the upstream adaptive module 110.

The upstream adaptive module 110 is also configured to handle split completions generated by PCIe complaint I/O device 106. The upstream adaptive module 110 may receive multiple completions for a given PCIe memory read request. These completion requests are intercepted by the upstream adaptive module 110 and a translated request based on one of the on-chip protocols is sent to the host processor 104.

In one example, the split completions received by the upstream adaptation module 110 are directly sent to the data bus of the host processors 104 along with corresponding response based on the completion status of the read request. Yet in another implementation, the received split completion data is stored in a local memory. In an example, a tag based memory location is utilized for ordering out-of-order completions. Upon stacking of all the split completions, a combined completion response is sent by the upstream adaptive module 110 to the data bus of the host processors 104.

It will be understood by a person skilled in the art that a similar communication for the split completions will happen between the I/O devices 106 and MPMRA switch 102 using the downstream adaptive module 112.

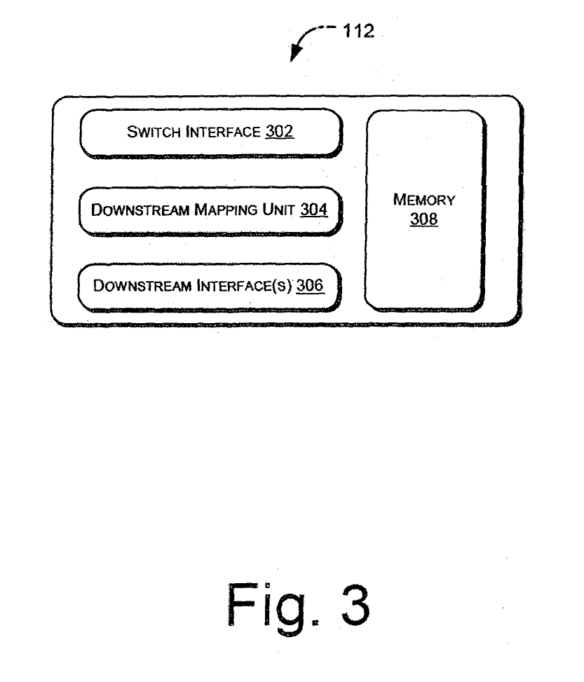

FIG. 3 illustrates a downstream adaptive module 112, in accordance with an embodiment of the present subject matter. Similar to the upstream adaptive module 110, the downstream adaptive module 112 includes a switch interface 302 to receive information from the switch routing nodule 108. In said embodiment, the downstream adaptive module 112 also includes a downstream mapping unit 304 to translate the information, received in a certain protocol from the switch interface 302, to a protocol at which the destination I/O device 106 operates. The ports are pre-configured such that a particular port of the downstream interface 306 exchanges information in a particular communication protocol.

Further, the downstream mapping unit 304 performs translation on the basis of the communication protocols in question. In an example, the translation is based at least on address spaces, completion status, and traffic classes of the communication protocols as discussed in FIG. 1. Also, the downstream adaptive module 112 is capable of handling atomic operations and intercept split completions generated by PCIe complaint I/O device 106. The atomic operations and the split completions are handled by the downstream adaptive module 112 in a similar manner as by the upstream adaptive module 110 as already explained FIG. 2. Therefore, the details of atomic operation handling and split completion handling have been omitted for the sake of brevity.

The translated information from the downstream mapping unit 304 is routed to the downstream interface 306, which further routes the translated information to the desired I/O device 106. In one embodiment, the downstream interface 306 includes either one master port or one slave port or both ports for exchanging information with the I/O devices 106. Also, the downstream adaptive module 112 is provided with a memory 308. The memory 308 may include a computer-readable medium known in the art including, for example, volatile memory, such as static random access memory (SRAM), dynamic random access memory (DRAM), etc., and/or non-volatile memory, such as erasable program read only memory (EPROM), flash memory, etc. In one implementation, the memory 308 may store the information and the translated information at run time.

Each I/O device 106 may implement multiple functions, and further, each I/O device 106, may be connected to multiple host processors 104. Therefore, effectively, each host processor 104 may control multiple functions and each I/O device 106 may be under multiple virtual hierarchies. In a virtualized multi-host environment, the downstream adaptive module 112 maps one or more I/O devices 106 or their functions to the one or more virtual hierarchies. For translation of information based on, the address space, the downstream adaptive module 112 maps the four parts of an address space, configuration space, Input Output(IO) space, memory space and message space to corresponding memory addresses, to be routed to any host processor 104 or an I/O device 106 which is complaint to any of the on-chip protocol.

The downstream mapping unit 304 may map various I/O device functions to fixed address space of on-chip protocol. Each root complex implemented by the host processors 104, has a virtual hierarchy number, and can only access the configuration space related to its virtual hierarchy. For a configuration request by a host processor 104, the downstream adaptive module 112 may translate the request into a fixed address based on the identified virtual hierarchy, the I/O device and the function number for the request.

Similarly, the IO space and the memory space are mapped by the downstream adaptive module 112. For each root complex implemented by the host processors 104, the PCIe IO and memory spaces are mapped to a fixed address space of on-chip protocols. In one embodiment, the downstream mapping unit 304 may maintain a lookup table for each of the root complexes identified by virtual hierarchies and their corresponding fixed address spaces. In said embodiment, for each received memory transaction, the downstream mapping unit 304 may look up the memory address in the lookup table, find the corresponding 10 entry for the Virtual Hierarchy and then translate the address to the corresponding address in the fixed address space of on-chip protocols based on the lookup table. Similarly, for IO transactions, a similar approach may be followed by the downstream adaptive module 112. Further, for an address which does not map to any entry in the lookup table, the downstream adaptive module 112 may send an Unsupported Request (UR) to the corresponding host processor 104.

Further, the downstream adaptive module 112 may handle the exchange of messages. In one implementation, messages are exchanged through programming registers stored in the configuration module 114, as explained in reference to FIG. 1 and FIG. 2.

In another implementation, the downstream adaptive module 112 may generate messages for the I/O devices 106. A non PCIe complaint I/O device 106 may generate an on-chip, AMBA AXI, AHB, VCI, PVCI, BVCI, AVCI, or an OCP write transaction. The transaction may be sent to the downstream adaptive module 112 along with a sideband signal, indicative of a request for message generation. For this request, the message header and the data of the message may be part of write data payload. The downstream mapping unit 304 of the downstream adaptive module 112 may extract the PCIe message from the write data payload, may format the message packet and send it to the upstream adaptive module 110.

Yet in another implementation, the messages to be sent to the host processors 104 may be stored in the memory 308 of the downstream adaptive module 112. For a message that needs to be sent upstream to the host processors 104, the I/O device 106 may only send a sideband signal to the downstream adaptive module 112. The sideband signal may be indicative of the type of message that needs to be sent and the corresponding message can be sent by the downstream adaptive module 112 to the required host processors 104.

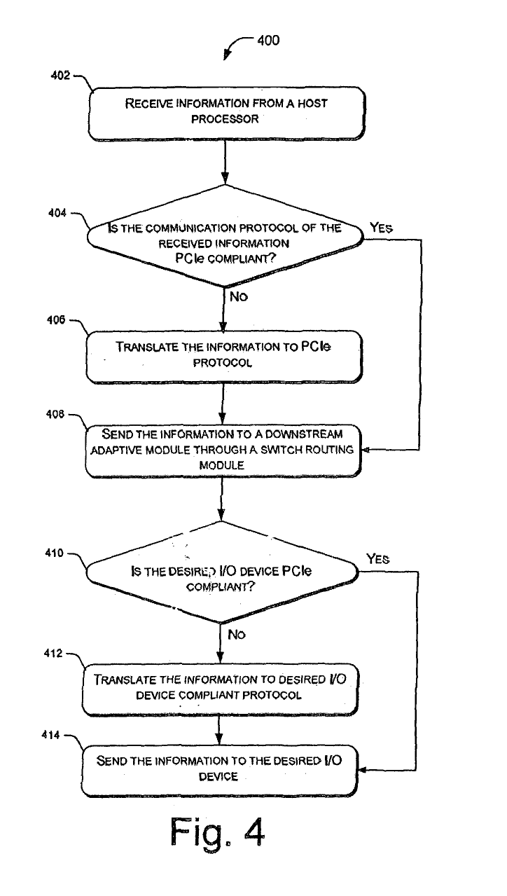

FIG. 4 illustrates a method 400 for transferring information from one communication protocol to another, according to an implementation of the present subject matter. The method 400 may be described in the general context of computer executable instructions embodied on a computer-readable medium. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400, or an alternative method. Additionally, individual blocks may be deleted from the method 400 without departing from the spirit and scope of the method, systems and devices described herein. Furthermore, the method 400 can be implemented in any suitable hardware, software, firmware, or combination thereof.

Additionally, the method 400 illustrates an implementation of conversion from AXI to PCIe protocol and is intended to be construed as a limitation of the present subject matter. The method has been described from the context of the computing system 100 however other embodiments may also be possible as will be understood by a person skilled in the art.

At block 402, information to be transferred is received from a host processor. In one implementation, the upstream adaptive module 110 receives information from a host processor such as the host processor 104-1 through a root complex.

At block 404, it is determined whether the information is PCIe compliant. For example, the upstream adaptive module 110 determines whether the information is PCIe compliant based on the port of the upstream adaptive module 110 where the information is received. In case the determination is negative, the control flows to block 406 (“No” branch). However, in case of a positive determination, the control flows to block 408 (“Yes” bench) where the received information is directly sent to the downstream adaptive module 110.

At block 406, the information is translated into PCIe compliant information. In one implementation; since the information received from the host processor 104-1 is not PCIe compliant, the information is translated into PCIe compliant information for the switch routing module 108. The translation is based on the protocol of the received information and predefined parameters, such as completion status responses, traffic classes, and address spaces. For example, if the host processor 104-1 sends the information in AXI protocol, the upstream adaptive module 110 implements address decoding to map a single address space in the AXI compliant information to multiple address spaces in the PCIe protocol. The message address space of the information is handled through the configuration and programming registers in the configuration module 114. Additionally, the upstream adaptive module 110 also maps the traffic classes of the PCIe protocol to the QoS encodings of the AXI protocol, and the communication responses to the PCIe protocol.

At block 408, the information is sent to a downstream adaptive module through a switch routing module. For example, if the information is translated by the upstream adaptive module 110, the translated information is sent to the downstream adaptive module 110 through the switch routing module 108 for further processing.

At block 410, it is determined whether the desired I/O device is PCIe compliant. In one implementation, the I/O device 106-1 is the device for which the host processor 104-1 sent the information. The downstream adaptive module 112 determines the port at which the I/O device 106-1 is connected to ascertain whether the I/O device 106-1 is PCIe compliant. If the determination indicates that the I/O device 106-1 is PCIe compliant (“Yes” branch from the block 410), then the translated information is directly sent to the I/O device 106 at block 414. If, however, it is determined that the I/O device 106-1 is not PCIe compliant (“No” branch), then the downstream adaptive module 112 re-converts the translated information into the protocol at which the I/O device 106-1 operates. Such a translation is also based on the protocol of the received information and predefined parameters, such as completion status responses, traffic classes, and address spaces as described in block 406. Subsequent to translation, the information is sent to the desired I/O device 106-1 at block 414.

Although implementations of a multi-protocol multi-root aware switch have been described in language specific to structural features and/or methods, it is to be understood that the invention is not necessarily limited to the specific features or methods described. Rather, the specific features and methods are disclosed as implementations for the multi-protocol multi-root aware switch.

1. A method for translating information in a multi-host computing system comprising:
receiving information, from a host processor, from amongst a plurality of host processors, in a primary protocol; wherein at least two host processors from amongst the plurality of host processors form different root complexes, and wherein the primary protocol for at least one host processor from amongst the plurality of host processors is non Peripheral Component Interconnect express (PCIe);
translating the information from the primary protocol to an intermediate protocol, wherein the intermediate protocol is implemented by a multi-root aware switch; and
translating further, the information from the intermediate protocol to a secondary protocol, wherein the secondary protocol is associated with an I/O device coupled to at least one of the plurality of host processors.

2. The method as claimed in claim 1, wherein the translation comprises mapping one or more of address spaces, completion status, traffic classes, atomic operations, and split completions from the primary protocol to the secondary protocol, and wherein the secondary protocol is associated with the I/O device coupled to at least one of the plurality of host processors.

3. The method as claimed in claim 1, wherein the method further comprises
providing the information in the secondary protocol to the I/O device, wherein at least two host processors from amongst the plurality of host processors adhere to different communication protocols.

4. The method as claimed in claim 1, wherein the translation from the primary protocol to an intermediate protocol PCIe address space comprises mapping of a primary protocol address space into configuration address space, I/O address space, memory address space, and message address space.

5. The method as claimed in claim 1, wherein the primary protocol is one of virtual component interface (VCI), basic virtual component interface (BCVI), advanced extensible interface (AXI), advanced high performance bus (AHB), peripheral component interconnect express (PCIe), advanced virtual component interface (AVCI), open code protocol (OCP), peripheral virtual component interface (PVCI), and brain computer interface (BCI).

6. A system comprising at least one upstream adaptive module configured to translate information from a primary protocol to an intermediate protocol for a multi root aware switch coupled to the upstream adaptive module, wherein the information is received from a host processor from amongst a plurality of host processors and provided to an I/O device, from amongst the plurality of I/O devices, adhering to a secondary protocol; and wherein at least two host processors from amongst the plurality of host processors form different root complexes, and wherein the primary protocol for at least one host processor from amongst the plurality of host processors is non Peripheral Component Interconnect express.

7. The system as claimed in claim 6, wherein the system further comprises at least one downstream adaptive module configured to translate the information from the intermediate protocol received from the multi root aware switch, to the secondary protocol, wherein the downstream adaptive protocol provides the translated information to an the I/O devices in the secondary protocol.

8. The system as claimed in claim 7, wherein the secondary protocol is one of virtual component interface (VCI), basic virtual component interface (BCVI), advanced extensible interface (AXI), advanced high performance bus (AHB), peripheral component interconnect express (PCIe), advanced virtual component interface (AVCI), open code protocol (OCP), peripheral virtual component interface (PVCI), and brain computer interface (BCI).

9. The system as claimed in claim 6, wherein the system further comprises a configuration module coupled to one or more of the upstream adaptive module and a downstream adaptive module configured to implement one or more of a configuration register set, and a programming register set for a plurality of I/O devices, and wherein each of the one or more configuration register set and the programming register set correspond to a host processor from amongst a plurality of host processor.

10. The system as claimed in claim 9, wherein the configuration module is further configured to translate the address space of the primary protocol and the secondary protocol to the address space of the intermediate protocol based on address decoding, and wherein the intermediate protocol is peripheral component interconnect express.

11. The system as claimed in claim 10, wherein the intermediate protocol is peripheral component interconnect express (PCIe), and wherein the address decoding comprises mapping the address space of the primary protocol to at least one of a configuration address space, an I/O address space, and a memory address space.

12. The system as claimed in claim 9, wherein the configuration module is further configured to provide a primary protocol message to at least one of the plurality of I/O devices from at least one of the plurality of host processors based on a message address space of the intermediate protocol, and wherein the intermediate protocol being PCIe.

13. The system as claimed in claim 9, wherein the configuration module is further configured to provide a secondary protocol message to at least one of the plurality of host processors from at least one of the plurality of I/O devices based on a message address space of the intermediate protocol, and wherein the intermediate protocol being PCIe.

14. The system as claimed in claim 9, wherein the upstream adaptive module is further configured to notify a host processor from amongst a plurality of host processors of a pending message from an I/O device.

15. The system as claimed in claim 7 wherein the system further includes a switch routing module coupled to one or more of the upstream adaptive module and the downstream adaptive module configured to route information between the plurality of host processors and the plurality of I/O devices based on switch configuration registers.

16. The system as claimed in claim 6, wherein the information is at least one of a completion status, a traffic class, an atomic operation, and a split completion.

17. The system as claimed in claim 6, wherein the upstream adaptive module is configured as one of a master port, a slave port, and a combination thereof.

18. The system as claimed in claim 6, wherein the downstream adaptive module is configured as one of a master port, a slave port, and a combination thereof.

19. The system as claimed in claim 6, wherein the system further includes a memory coupled to the configuration module configured to implement virtual channel buffers for the plurality of host processors and the plurality of I/O devices.

20. The system as claimed in claim 6, wherein the upstream adaptive module is further configured to handle out-of-order completions from an I/O device from amongst the plurality of I/O devices to provide to a host processor from amongst the plurality of host processors.

21. The system as claimed in claim 7, wherein the downstream adaptive module is further configured to handle out-of-order completions from a host processor from amongst the plurality of host processors to provide out-of-order completion signal to an I/O device from amongst the plurality of I/O devices.

22. The system as claimed in claim 6, wherein the upstream adaptive module is further configured to provide completion timeout signal to a host processor from amongst the plurality of host processors.

23. The system as claimed in claim 7, wherein the downstream adaptive module is further configured to provide unexpected completion signal to an I/O device from amongst the plurality of I/O devices.

24. The system as claimed in claim 6, wherein the upstream adaptive module is further configured to receive message from at least one of the plurality of host processors in the primary protocol through a side band signal.

25. The system as claimed in claim 7, wherein the downstream adaptive module is further configured to receive message from at least one of the plurality of I/O devices in the secondary protocol through a side band signal.
